(19) United States
(12) Patent Application Publication
(10) Pub. No.: US 2006/0149647 A1
(43) Pub. Date: Jul. 6, 2006

(54) Reverse purchase property transfer transaction and method of administering same

(76) Inventors: Stephen J. Sogin, Occidental, CA (US); Joseph J. Catalano, San Francisco, CA (US)

Correspondence Address: VIERRA MAGEN MARCUS & DENIRO LLP, 575 MARKET STREET SUITE 2500, SAN FRANCISCO, CA, 94105, US

(21) Appl. No.: 11/027,544

(22) Filed: Dec. 30, 2004

(51) Int. Cl. G06Q 40/00

(52) U.S. Cl. 705/35

(57) ABSTRACT

A method of selling real property and a financial transaction are disclosed. The financial transaction comprises a contract for the sale of real property in installments over a discrete time period where the transfer of possession and title from Seller to Buyer does not occur until at least completion of all payments. The includes the steps of: establishing a value for the property that generally results in a discounted value; setting a term for installment payments on said discounted value for the property; receiving installment payments on said discounted value for at least a portion of said installment period; and prior to completion of said term, selling said property and providing at least a proportional share of any proceeds from the sale of said property to the Buyer or in the alternative, upon completion of said term, transferring title of said property to the Buyer.

### BACKGROUND OF THE INVENTION

1. Field of the Invention

The present invention is directed to the purchase of real estate.

2. Description of the Related Art

The market of individuals needing to access the equity available in their homes is growing, with some estimates noting 78 million Americans who are 50 older controlling 67% of the nations wealth, or some 28 trillion dollars, most of which is tied up in paper profits in home equity. The proportion of Americans above the age of 50 is expected to be 33% of the population within 5 years.

For homeowners over the age of 62 who do not qualify for home equity loans, due to lack of qualifying income or other reasons, the most common way to realize cash from their equity is through a “reverse mortgage”; a loan against one's home that one need not repay as long as one remains in the home. With a reverse mortgage, one can convert some of the value of one's home into cash without ever having to move or make monthly payments to repay the loan. In those cases where the equity of the homeowner is already encumbered, reverse mortgage financing opportunities are severely restricted, and in some cases, impossible. In 1989, for homeowners over the age of 65, 1 in seven still had mortgage obligations. In 2000, the number has increased to one in three. By 2010, the number is estimated to rise to one in two. As these individuals retire, earnings are no longer available to make payments on these obligations, and these individuals will need to find a mechanism to generate the cash flow to make their mortgage payments.

A reverse mortgage typically need not be repaid until the property owner dies, sells the home, or permanently moves out of the home. To be eligible for most reverse mortgages, the property owner must be 62 years of age or older.

Reverse mortgages are funded with extremely low Loan to Value limitations, and are highly regulated by the Federal Government. In addition, interest charges consume additional equity in the property.

The most common method employed to purchase residential property is direct purchase with a down payment and the remainder of the purchase price in the form of mortgage debt. There are now numerous different mortgage products, which have become highly diversified and complex. Almost anyone with the capacity for repayment is able to find a financing product to purchase a home.

Another method for purchasing a home, which has fallen out of favor due to loan products that offer 100% financing for example, is the land sale installment contract. With a conventional land sale installment contract purchase, there is no requirement for a down payment, payments are made over a fixed period, the Buyer lives in the property, and the Seller receives the purchase price in installments. Title does not pass to the Buyer until the last payment is made. In the event of the Buyer's default, the Seller's remedy is to keep all monies received and retain ownership of the property. The Seller also benefits from any property appreciation that may have occurred before the default has occurred.

### SUMMARY OF THE INVENTION

In one aspect, the invention is a financial transaction comprising a contract for the sale of real property in installments over a discrete time period where the transfer of possession and title from Seller to Buyer does not occur until at least completion of all payments.

In another embodiment, the invention is a method for selling a piece of property by a seller to a buyer. The method includes the steps of: establishing a value for the property that generally results in a discounted value; setting a term for installment payments on said discounted value for the property; receiving installment payments on said discounted value for at least a portion of said installment period; and prior to completion of said term, selling said property and providing at least a proportional share of any proceeds from the sale of said property to the Buyer or in the alternative, upon completion of said term, transferring title of said property to the Buyer.

In another embodiment, the invention is a method for buying a piece of property by a Buyer from a Seller. The method may include the steps of: establishing a value for the property; setting a term for installment payments on said value for the property; providing installment payments on said value to the seller for at least a portion of said installment period; prior to completion of said term, receiving at least a proportional share of any proceeds from the sale of said property by the Seller, or in the alternative, upon completion of said term, receiving title of said property to the Seller.

In a further embodiment, the invention is a method for doing business, comprising gathering a plurality of reverse purchase contracts of sale; and bundling RPCS contracts as an investment instrument.

### BRIEF DESCRIPTION OF THE DRAWINGS

FIG. 1 is a depiction of the general contractual method of the present invention.

FIG. 2 depicts various methods of the present invention.

FIG. 3 depicts an alternative embodiment of the present invention.

FIG. 4 depicts a life-estate alternative to the contractual method of the present invention.

### DETAILED DESCRIPTION

The invention includes a transactional method for transferring ownership of property, and methods for administrating the transaction. In a unique aspect, the transaction allows a delay in the transfer of possession and occupancy of the property from a seller to a buyer until the completion of the payments for the property. In one aspect, the transaction is facilitated by an Administrator who generates income by providing facilitation services. The transaction method of the present invention provides a real estate investment that offers superior returns to a buyer and structured payments to the Seller through a novel and proprietary financing concept meeting a growing market need. Safety to the seller in the event of a buyer default is provided in that such a default will not trigger a re-payment obligation.

In general, the method allows the homeowner to monetize the equity in his property in installments through the sale of the property with the purchase price paid over a fixed period of time, with the homeowner remaining in the home until the purchase price is fully paid. In one version, at the time the purchase price is fully paid, and unlike a reverse mortgage, the purchase is completed and the Seller must vacate the home. In another alternative, the Seller may remain in the home until an alternative event occurs—such as the death of the Seller or the passage of a period, for example one year, in which the Seller can no longer occupy the home.

The transactional method of the present invention provides a mechanism for older homeowners to convert home equity into cash without a repayment obligation while remaining in their homes. The invention will have particular applicability for homeowners who have a need for additional income and who find conventional financing unsuitable or unavailable. In one aspect, such homeowners may comprise persons who are at least 62 years of age and who have a desire to access the equity built up in their homes without incurring debt. However, the invention is not limited to sellers of a limited age group. The income stream from the system of the present invention will allow these homeowners to maintain their life styles and to have additional income to meet medical expenses, as a supplement to medical insurance, for other necessities, the purchase of an annuity or for discretionary spending.

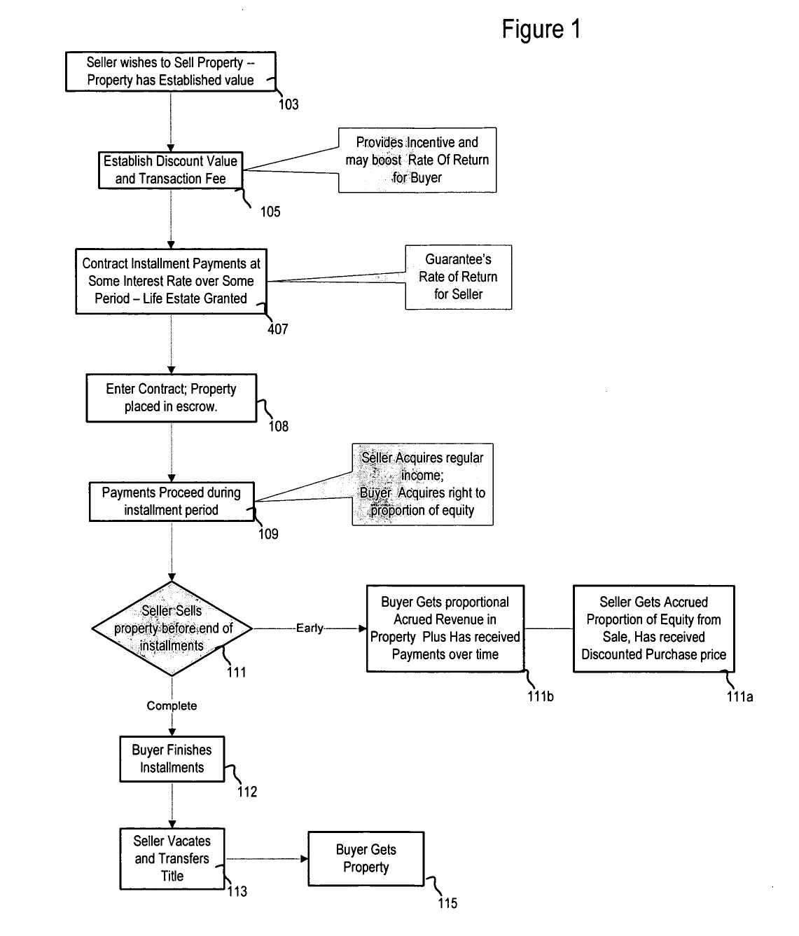

FIG. 1 illustrates an exemplary Reverse Purchase Contract Sale (RPCS). Suppose that an owner (Seller) of property wishes to sell a piece of property using the method of the present invention. In this method, the Seller is allowed to retain possession and, to some extent, control of the property until completion of the sale at the end of a payment period. While variations may be accommodated, for purposes of an exemplary transaction described herein, the owner will be assumed to own the property in full. In an alternative embodiment of the invention, the owner may be a partial equity owner.

At step 103, the price of the property for sale will be established under market conditions at the time the RPCS is entered. The established price may be set by appraisal or other means, such as mutual agreement. A discounted price for the property may be established at step 105. This discount may be a percentage of the established price, a fixed fee, or a combination of both. The discount provides an incentive for the Buyer to enter into the purchase agreement—the Buyer is purchasing the property at a discount. In addition, a transaction fee may be established. The transaction fee may serve to compensate a transaction administrator, broker or agent who facilitates the transaction for the buyer and seller.

An installment term for the sale is agreed upon at step 107. In general, the Buyer will pay the established purchase price less the discount and the transaction fee, with the fee being amortized over the installment period to the Seller. In this manner, the Buyer has a contract to purchase the property for an established purchase price and pays for it over an agreed period of time. The Seller receives a regular stream of income, and sells the property for the price agreed to at the time of entry into the RPCS, which approximates the amount they would have received under a conventional sale at the time of entry into the RPCS. At step 108, when the contract is executed, title to the property may be placed in escrow under instructions suitable for implementing the agreement as specified herein.

The incentive for the Seller is laid out in the terms of the contract—a regular stream of income. In one example, the discount to the appraised value for making the commitment is set at a percentage of the appraisal value. As provided in the RPCS, the Seller conveys that percentage of the Seller's interest in the property at the time the parties enter into the agreement, such that the Buyer acquires an equitable ownership in that percentage outright from the day the contract is signed. In addition, as a further incentive, a transaction fee may be charged. This fee may be an additional percentage, which the Seller also agrees to pay in installments amortized over the life of the contract. This charge is comparable to the commission normally paid on the sale of the property. The payments on this borrowing will be deducted from the installment payments. No interest will be charged on the transaction fee. Title will transfer by deed at completion of payment obligation, but a memorandum of sale will be recorded at time contract is entered to immediately put notice of the transaction in the public record.

Under the terms of the RPCS sale, the Seller lives in the property until the parties conclude the transaction. The trade off is that in exchange for providing the installment payments, the Seller grants an initial discount to the appraised value of the property and agrees that any appreciation of the property goes to the Buyer. The Seller is also responsible for taxes, insurance and standard maintenance. In one alternative, an escrow account for maintenance and taxes will be established such that insurance and taxes are paid as a deduction from the payment stream. In one embodiment, a portion of the monthly purchase price is deposited into a separate escrow account for maintenance expenses. Unused portions of this account can be released to Seller periodically after inspections verify good repair.

As a condition of the transaction, no additional borrowing using the property as security is permitted after the contract is entered. Remedies may be installed in the contract if the Seller attempts to further encumber the property. By way of example, all payments otherwise payable to home Seller may be required to go to retire the impermissible debt.

Payments proceed under the installment period at step 109. Next, at step 111, two options for termination of the agreement are presented—the contract is fulfilled by the completion of the installment payments over the term or by the Seller terminating the contract by moving out of the property.

In one embodiment of the invention, the Seller may have the option to terminate the contract by selling the property before the completion of the installments. For example, it is conceivable that the Seller would prefer to move out of the property before the completion of the installment term, or perhaps the Seller passes on, leaving the estate to deal with the Seller's remaining interest in the property. At this point, since the property is sold to a third party prior to the completion of the RPCS term, at steps 111a and 111b, the Seller will immediately receive the unpaid balance of the purchase price pursuant to the RPCS (130). The Seller would have already received the installment payments for the period of the installment contract prior to the subsequent sale. The RPCS Buyer will receive the balance of the third party sales proceeds (120). To illustrate such an instance, if for example, the children of a Seller believed that early term appreciation would continue over the remainder of the RPCS term, they could purchase the property at any time at the then current market price, with the purchase price proceeds payable in accordance with the terms of the RPCS. The distributions of proceeds from sale prior to the end of term are discussed further below.

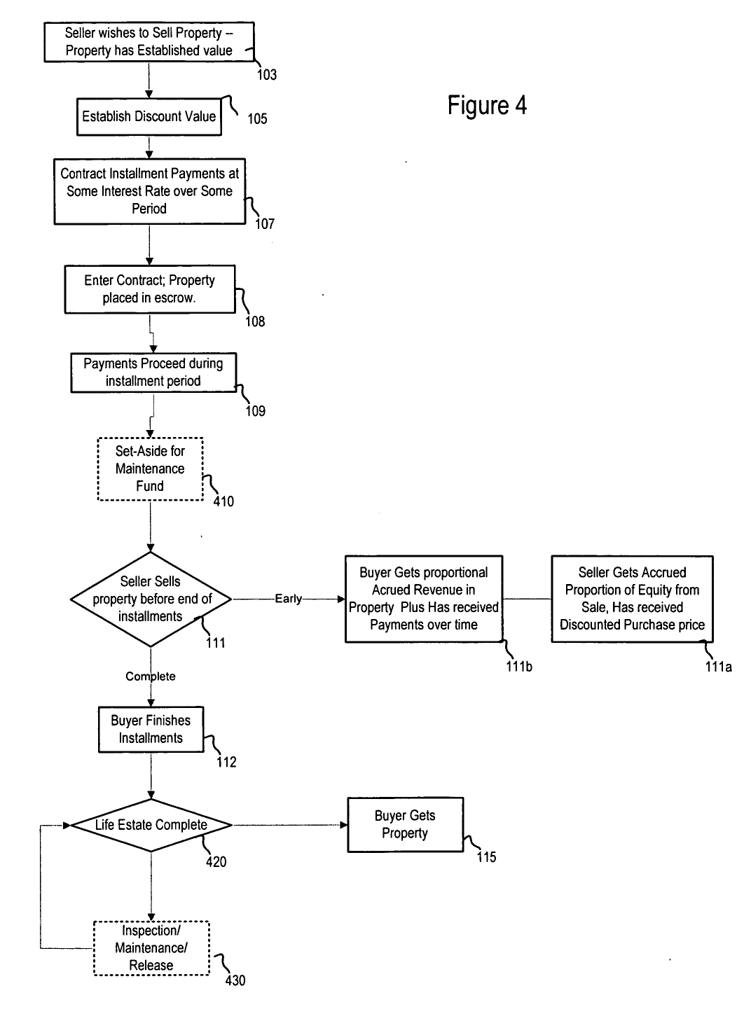

Alternatively, if the contract is paid until completion at step 111, the buyer completes installment payments at step 112, the title to the property is transferred to the Buyer and the seller vacates the property at step 113, and ownership of the property vests in the Buyer at step 115. In one alternative, discussed below with respect to FIG. 4, a life estate may be granted to Seller by which the Seller retains the right to remain in the home for the remainder of his or her life. In this instance, after completion of the contractual payments, any taxes imposed as a result of the life estate are the responsibility of the seller.

Unlike conventional sale agreements, in the RPCS, the Seller retains possession and control of the property during the purchase period, and can, if necessary, accelerate receipt of the remaining payments due under the RPCS any time prior to completion.

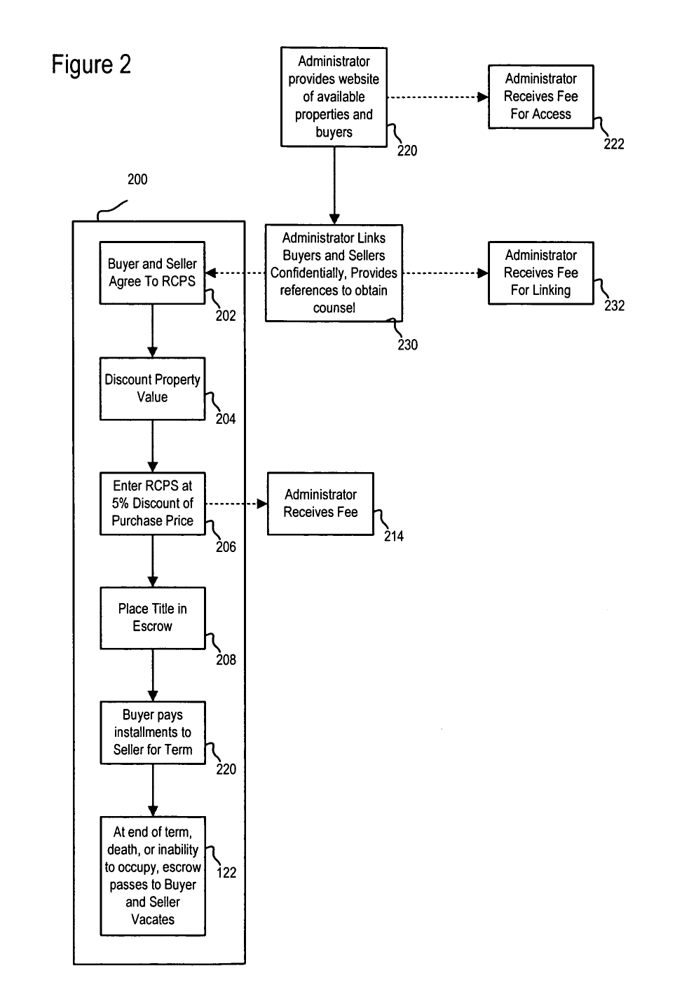

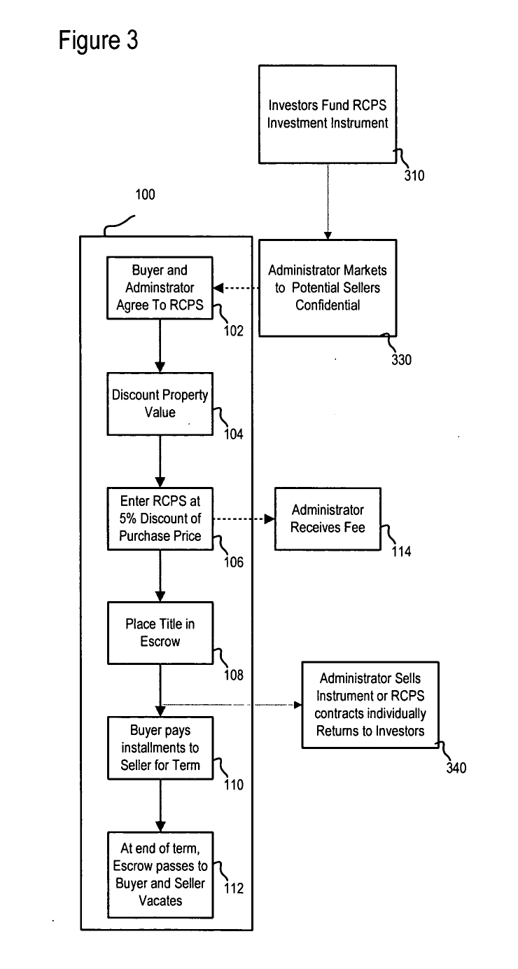

Two additional variations wherein an Administrator may facilitate RPCS transactions of the method are shown in FIGS. 2 and 3,. In general, a first variation of the method of the present invention is shown in FIG. 2. The transactional method 200 is shown in relation to the manner in which a system Administrator may assist and facilitate the transaction, as well as obtain remuneration for such assistance.

At step 202, the Buyer and Seller will agree to an RPCS transaction. One aspect of the method may include the Administrator providing a website or other promotional and disclosure materials to facilitate bringing investors into the program at step 220. For example, a website may provide a listing of contracts available for investment to interested investors in a sortable fashion, enabling the Administrator to combine investors with RPCS contracts as an investment instrument. For example, the Administrator may gather a plurality of contracts together and offer such contracts as a security or bundled investment. The dashed line linking these two steps indicates that step 222 is not required, but optional.

In addition, and again prior to the agreement, the Administrator may link potential investors with prospective purchases through the website or through other data gathering means, as indicated at step 230. Again, at step 232, the Administrator may charge a fee for this service.

Once the Buyer and Seller have agreed at step 202, at step 204, a discount to the appraised value is taken at the time the sale agreement is made. As noted above, this provides a discount from present value incentive for the Buyer. In addition, at step 206, an additional real estate fee is assessed at the time the contract is signed. In yet another alternative of the invention, the Administrator receives this fee at step 214.

At step 208, upon execution of the agreement, the title is placed in escrow. A memorandum of sale describing the transaction is recorded at the recorders office.

After this point, the Buyer commences making installment payments to the Seller for the term of the purchase contract as indicated at step 210.

When the Seller can no longer occupy the property due to death or illness for an agreed period of time, the property is sold. The Seller may have chosen the election to sell the property at any time during the life of the contract. Alternatively, the Seller may elect to remain in the property after the completion of the payments due under the contract, if the parties have negotiated a life estate in the property for the Seller, as discussed below with respect to FIG. 4. This status permits the Seller to continue the enjoyment of the home as long as it is occupied by the original Seller.

As in the first example, when the property is sold, the Buyer receives the net sale proceeds after paying the Seller the remaining amounts payable pursuant to the RPCS. Thus, the Buyer receives any previously purchased equity based on the initial price set plus the portion of the equity purchased through the revenue stream and whatever portion of the real estate fee that has not been amortized during the life of the contract.

The Administrator may provide the additional service of investigating the financial history of the Seller. The Seller may be required to have legal representation to insure that the terms of the transaction are fully understood.

Additional provisions may allow the Seller to terminate the contract at any time by offering the house for sale. In another embodiment, the Administrator may be given the option to purchase the property on an accelerated basis at the original appraised value less money earned. Fees incurred in such a sale would be shared on a proportional basis determined by ownership percentages.

Since title does not pass until the transaction is completed, in most cases it is generally understood that property taxes will remain at the Seller's rate, which will be lower than that of the Buyer in most instances. Since the RPCS contract provides for the Buyer to receive up to 100% of the increase in value of the property, the leverage provided reverses the lender's model, while providing the Seller with an institutional counterparty. Although the Seller remains responsible for insuring and paying taxes on the property while in possession, any increase in these expenses attributable to increased appraised value will be borne by the Buyer, since the Buyer will ultimately receive the net value added by appreciation.

Unlike commercial lenders, the Buyer has broad control over the properties and sellers chosen for purchase transactions. Areas perceived as most likely to realize higher than average appreciation will be favored.

There are many advantages to the Seller. The primary advantage is that it allows the Seller to monetize virtually all of the equity in his property far more efficiently than using any other commercially available mechanism. Because a seller may be retired, the ability to qualify for mortgage financing is severely limited. Of at least equal importance, the Seller can remain in the property and not be forced to move during the term of the RPCS, and if the life estate option has been chosen, not at all, even after the contract has been completed and title passes to the Buyer. Under the basic RPCS, the Seller may remain in the home during the term of the contract, unless the Seller is forced to vacate by death or inability to live in the home for more than a contractually agreed period of time; events which will result in sale to a third party and distribution of those sale proceeds under the terms of the RPCS. Protecting the Seller's opportunity to remain in possession of their residence is a significant issue for individuals who have lived in a given location for 20 years or more. The extra income from the RPCS would support a more comfortable lifestyle or provide support for other needs of children or grandchildren. Trusts can be funded for the benefit of the heirs. The revenue stream could also be used to retrofit the dwelling to accommodate infirmities which require upgrades such as handrails, ramps, elevators and specialized toilets. The RPCS also allows the Seller to preserve financial independence without sacrificing quality of life. The income from the RPCS can be used by the Seller to purchase an annuity or other financial instrument that can be used by the Seller as a funding source after the conclusion of the payment stream from the RPCS. This circumvents any need for support at a difficult time for the following generations. Because of generational separation of 25 years or so, just at the time the parents may need support, their children are facing a cash squeeze with their own children's college and other needs. Most importantly, the funds paid pursuant to the RPCS do not have to be repaid, and are received over a protracted period of time, which may reduce recipient's taxation and limit opportunities for imprudent expenditure of sale proceeds. The method of the present invention provides liquid financial resources, to elderly sellers at a much lower cost than prior methods. The method of the present invention provides liquid financial resources, to elderly sellers at a much lower cost than prior methods. The RPCS program can provide over $3.5 trillion to this population and provides more liquidity than reverse mortgages, provides additional benefits, and eliminates many of the liabilities including the high closing costs associated with reverse mortgages.

FIG. 3 shows another alternative of the invention, where the Administrator is the Buyer. In FIG. 3, like references numerals represent similar elements to those shown in FIG. 2. In this instance, the Administrator may gather investors to create a financial investment instrument that can be used to purchase property using the RPCS transaction at step 310. At step 330, the Administrator may market its opportunity to potential sellers. At the completion of one or more (but most likely several) RPCS transactions, the Administrator may provide returns to investors by selling contracts to other investors 340, or waiting for property sales to provide a return to the original investors. The Administrator may charge additional fees for this service. In this instance, the cash flow model indicates that negative cash flow will need to be addressed. This may be approached by selling these contracts to third parties. This issue can also be addressed by the structure of an Administrator as an investment company or an investment fund.

FIG. 4 illustrates a number of additional variations on the base transaction illustrated in FIG. 1. In a first aspect, the parties may agree to provide the seller with a life estate in the property. A life estate may be of particular interest to elderly sellers who may not be able to find alternative housing at the end of the installment period. In FIG. 4, elements shared with FIG. 1 are commonly numbered.

As shown at step 407, a life estate may be granted in accordance with the initial agreement. As an optional step when a life estate is granted, or even where a life estate is not granted, a set-aside fund may be established for maintenance and upkeep of the property during the contract period, the succeeding, post-payment life estate period, or both. In accordance with the life estate grant, at step 420, title is vested in buyer, subject to the life estate of seller, and buyer will not obtain occupancy of the property at step 115 until the completion of the life estate.

Optionally, a number of inspection and maintenance terms may be provided at step 430. Although the position of step 430 is shown as being subsequent to the completion of the installment payments, it should be recognized that step 430 can occur at any point subsequent to step 107. In a first alternative, the contract may provide that the tax and maintenance fund, discussed briefly above, be established at step 410 to protect the investment of the buyer when maintenance is required on the property. Provisions for inspection of the property by the buyer and use of the maintenance account can take many forms. For example, inspections may be allowed at regular intervals or as requested by the buyer, during the contract payment period or only subsequent thereto. Following an inspection, the buyer may be required to sign a release. If repairs are thought to be required, the parties may use the fund by mutual agreement or, if both parties do not agree, the Administrator may serve to mediate any dispute as to the use of the maintenance funds. The use of the reserve fund need not be limited to repairs. The amount of the fund may include funds to protect against the inability of the seller to pay for taxes on the property after contract payments from the seller have ceased. Provisions may be made for return of unused maintenance and tax funds when property is transferred to the buyer. Taxation of the life estate should only commence after title passes, when use of the life estate commences.

An exemplary calculation illustrating the benefits of this transaction is set forth below. For purposes of this calculation, the average transaction is assumed to end early, 10 years into a full 15 year term, and the seller either dies or can no longer live in the house. In one example, assume:

Home Appraisal Value=$500,000

5% Discounted Value=$475,000

Transaction Fee=$25,000 (5% of value—amortized over life of contract)

Buyer Price=$450,000

Monthly Payment=$2497 (approximately)

Discount Rate=6%

Net Present Value of Home=$291,000

If the property were to sell after 10 years with an appreciation rate of 5% per year, the values to calculate the proceeds returned to the buyer would approximate the following:

Starting Value=$500,000

Estimated 10 year Appreciated Value=$814,447
Net Gain=$314,447

Commitment (Transaction Fee) Proceeds=$25,000 (5% of $500,000) (to Administrator)

Sellers Proceeds From Equity=$144,150 (seller has also received $299,640 in monthly payments over the 10 year period)

Administrator Proceeds=$25,000

Sellers Equity Purchased=$318,250

5% Original Ownership=$25,000

Buyer's Total $670,297 (Sum of Equity Proceeds plus Discounted Value plus Commitment Fee)

NPV for 10 years $220,554

Compounded Rate of Return 11.8%

The costs of closing an RPCS are far lower than a conventional mortgage. There is less paper work with fewer disclosures required. Most of the disclosure burden would fall on counsel to the Seller that would be required as a part of the contract. There are title insurance products available that will insure against fraudulent conveyance that may also be required. In one estimate, the amount of paper involved in the transaction would fall by 75%, compared to a conventional sale financed with a mortgage.

Interest rates have an impact on the residential real estate market. Historically, when interest rates are high, property appreciation will slow. When interest rates are low, appreciation rates are higher. Both of these observations are related to the size of the monthly payment on the property. People tend to pay what they can afford. Lower interest rates allow the purchase of more expensive real estate, and to a certain extent the market rises to accommodate that capacity. Higher interest rates do not eliminate the overall trend toward higher real estate prices. There are still more individuals who want to own their homes than there are units available. The instant invention is structurally buffered from interest rate fluctuation. When interest rates rise, property appreciation slows and the discount factor rises. In effect, under these circumstances, the slowing in the appreciation of property is offset by the rise in the discount factor, since the net present value of the total of the payments is less than it is when interest rates are lower. The RPCS system is ahead of the real property appreciation curve. If residential property appreciates at 7%, the return will be at 12% using current rates of appreciation and current discount rates, if the transaction goes to completion. The business model is sensitive to length and duration of the contract. Shortened duration contracts (early exits) produce higher returns because of the up-front loading of the discounts and fees.

The downside risk is also very low since the property would have to decrease in value by 40% or more before the proposition loses money. Income to the Seller is also likely to be taxed at a lower rate, given the reduced income of retired Sellers. Similar to a mortgage, the RPCS instrument would be in a secured position in case of bankruptcy. Because of the discounts, the investor always gets a higher return than average on the real estate that is purchased with greater safety.

In a further embodiment, the Administrator may provide a revenue stream to the Seller. A Seller with an unstable financial background can provide difficulties that would add expense to the transaction. The credit history of each client would be investigated to eliminate those potential clients with low credit scores. These clients are at a greater bankruptcy risk. The RPCS will be structured to minimize the effect of a bankruptcy filing by the Seller. The RPCS may be structured to mitigate higher credit risks by modifying the initial discount in favor of the Buyer.

The Administrator can facilitate marketing the transaction to buyers and sellers. There are a number of potential marketing channels available for originations, including estate planners, organizations that deal with seniors such as AARP, insurance agents, real estate agents, Mortgage brokers, and banks and other financial institutions. Channels exist for entities seeking exit strategies, such as alternative investment groups at banks, investment banks to sell a package of originations, mortgage banks and qualified Individuals. Alternatives also exist for financing sources, such as corporate Pension Funds, state Pension Plans, and foundations with an interest in the elderly.

For many of these potential financiers, this type of investment is mission critical to their function of providing for their retirees.

Any potential issues that arise subsequent to the signing of the contract may be mitigated by requiring that the Seller obtain legal counsel prior to entry into the RPCS Agreement.

Reverse Mortgages require the holder to take out Private Mortgage Insurance (PMI) to insure against worst-case scenarios. The rules governing reverse mortgages do not allow the lender to force the homeowner from their home. They can stay as long as they want with no payments made to the lender.

An example of a worst-case scenario on a home valued at $500,000 would have the following conditions.

The home owner borrows the maximum allowed based on age and the value of the home;

The value of the property declines by 50% when the homeowner vacates;

The remaining equity in the home does not make up for the accumulated interest and loan amount;

There is a loss to the lender.

The loss is made up by Private Mortgage Insurance which is a major source of the high closing costs associated with reverse mortgages. The RPCS invention also differs in this regard because the Seller is not required to purchase PMI in a RPCS Agreement.

A similar source of insurance can be secured for the Administrator costing much less since it need only insure against the loss of more than 35-40% of the principal value of the home at the time of purchase. There is no interest accumulating while the Seller remains in the property. The exposure for the insurance company should be much less. A far lower premium should result. Using the same worst-case scenario, the loss to the Administrator would be $41,000 in principal, using the NPV calculation and $200,000 in hard dollars. Both of these calculations assume the contract runs the full 15 years.

The foregoing examples have illustrated the invention with respect to full ownership situations. Other ownership arrangements by the seller may be accommodated. In one embodiment where the seller is a partial owner of the property, the delivery of a deed need not be signed by all current owners and may convey only the interest that a particular seller has in the property. Such alternative ownership arrangements may include joint ownership, joint with right of survivorship, tenancy in common, condominiums and the like. Still further, the property need not be limited to real-property transaction, but may include co-ops.

Still another embodiment of the invention accommodates a pre-existing debt on the part of the seller. Typically, where a first mortgage holder has an interest in the property, some form of “due on sale” clause requires payment of the balance of the mortgage when a transaction of sale involving the property occurs. The transaction of the present invention can be structured so that a particular clause is not triggered by the mortgage, or a separate agreement made with the first mortgage holder regarding implementing the reverse purchase contract.

Finally, bankruptcy protection can be built into the agreement. In this aspect, under Federal Bankruptcy law, an executory contract may be repudiated by a trustee in bankruptcy. Terms may be included in the transaction contract which provides that should the RPCS be rejected in bankruptcy, all payments made, and any unsatisfied obligations of the seller to buyer, will become secured by the property as in a mortgage, with a fixed or adjustable interest rate. Still further, the contract may provide that the mere filing of bankruptcy converts the RPCS to a mortgage with a fixed or adjustable interest rate to secure the repayment of all funds previously paid by buyer to seller.

The foregoing detailed description of the invention has been presented for purposes of illustration and description. It is not intended to be exhaustive or to limit the invention to the precise form disclosed. Many modifications and variations are possible in light of the above teaching. The described embodiments were chosen in order to best explain the principles of the invention and its practical application to thereby enable others skilled in the art to best utilize the invention in various embodiments and with various modifications as are suited to the particular use contemplated. It is intended that the scope of the invention be defined by, the claims appended hereto.

We claim:

1. A financial transaction comprising:
a contract for sale of real property comprising in installments over a discrete time period where the transfer of possession and title from Seller to Buyer does not occur until at least completion of all payments.

2. The transaction of claim 1 wherein the sale is based on a discount on an established value of the property made at the time of sale.

3. The transaction of claim 1 wherein the transaction further includes a provision preventing a Seller from borrowing additional funds against the real property during the installment period.

4. The transaction of claim 3 wherein the established value is a percentage of an appraised value for the property.

5. The transaction of claim 4 wherein the value is a percentage of an appraised value for the property plus a fixed fee.

6. The transaction of claim 1 wherein the transfer of the right of occupancy is delayed until the completion of a life estate.

7. A method for selling a piece of property by a seller to a buyer, comprising:
establishing a value for the property that generally results in a discounted value;
setting a term for installment payments on said discounted value for the property;
receiving installment payments on said discounted value for at least a portion of said installment period; and
prior to completion of said term, selling said property and providing at least a proportional share of any proceeds from the sale of said property to the Buyer or in the alternative, upon completion of said term, transferring title of said property to the Buyer.

8. The method of claim 7 wherein the value is a percentage of an appraised value for the property.

9. The method of claim 7 wherein the value is a percentage of an appraised value for the property plus a fixed fee.

10. The method of claim 7 wherein said step of receiving comprises receiving payments including interest on the discounted value.

11. The method of claim 7 further including the step of placing the property in escrow during the installment period.

12. The method of claim 7 further including the step of providing a fee to a transaction administrator.

13. A method for buying a piece of property by a Buyer from a Seller, comprising:
establishing a value for the property;
setting a term for installment payments on said value for the property;
providing installment payments on said value to the seller for at least a portion of said installment period;
prior to completion of said term, receiving at least a proportional share of any proceeds from the sale of said property by the Seller, or in the alternative, upon completion of said term, receiving title of said property to the Seller.

14. The method of claim 13 wherein the value is a percentage of an appraised value for the property.

15. The method of claim 13 wherein the value is a percentage of an appraised value for the property plus a fixed fee.

16. A method for doing business, comprising:
preparing a reverse purchase contract of sale from a Seller to a Buyer of real property; and
administering a reverse purchase contract of sale.

17. The method of claim 16 including the step of:
providing a website linking potential Buyers and potential Sellers.

18. The method of claim 16 wherein the reverse purchase contract of sale comprises a contract for the sale of real property comprising a sale of said real property in installments over a discrete time period based on a discount on an established value of the property made at the time of sale, and deferring the transfer of possession from Seller to Buyer until at least completion of all payments.

19. The method of claim 16 further including the step of brokering private mortgage insurance on the reverse purchase contract of sale.

20. The method of claim 16 wherein the step of administering includes acting as the Buyer.

21. The method of claim 16 further including the step of preparing a plurality of contracts, and bundling said contracts as an investment instrument.

22. The method of claim 21 further including the step of selling shares of said investment instrument.

23. A method for doing business, comprising:
gathering a plurality of reverse purchase contracts of sale; and
bundling RPCS contracts as an investment instrument.

24. The method of claim 23 wherein the reverse purchase contract of sale comprises a contract for the sale of real property in installments over a discrete time period based on a discount on an established value of the property made at the time of sale, and deferring the transfer of possession from Seller to Buyer until at least completion of all payments.

25. The method of claim 23 wherein the step of bundling comprises funding at least one or more of the contracts as an investor.

26. The method of claim 24 wherein the sale is based on a discount on an established value of the property made at the time of sale.

27. The method of claim 23 wherein the transaction further includes a provision preventing a Seller from borrowing additional funds against the real property during the installment period.

28. The transaction of claim 23 further including selling one or more of shares of a bundle of said contract.
